(19) United States
(12) Patent Application Publication
(10) Pub. No.: US 2023/0405986 A1
(43) Pub. Date: Dec. 21, 2023

(54) VACUUM-SEALING DEVICE AND VACUUM CHAMBER DEVICE

(71) Applicant: SINTOKOGIO, LTD., Nagoya-shi (JP)

(72) Inventors: Takemasa KONDO, Nagoya-shi (JP); Kyoji FURUKAWA, Nagoya-shi (JP); Keita SUZUKI, Nagoya-shi (JP); Yuki HAGA, Nagoya-shi (JP); Atsushi SUZUKI, Nagoya-shi (JP)

(73) Assignee: SINTOKOGIO, LTD., Nagoya-shi (JP)

(21) Appl. No.: 18/308,256

(22) Filed: Apr. 27, 2023

(30) Foreign Application Priority Data
May 23, 2022 (JP) 2022-083961

(51) Int. Cl. B32B 37/00; B32B 37/10

(52) U.S. Cl. CPC B32B 37/0053; B32B 37/10

(57) ABSTRACT

A vacuum-sealing device includes: a first roll; a second roll that contacts the first roll; a first holding member having a first space in which the first roll is held and which has an axis coincident with an axis of the first roll; and a second holding member having a second space in which the second roll is held and which has an axis coincident with an axis of the second roll. The first holding member has an inner circumferential surface that faces the outer circumferential surface of the first roll, and rotation of the first roll and the second roll in correspondence with each other causes a sheet material to pass.

This Nonprovisional application claims priority under 35 U.S.C. § 119 on Patent Application No. 2022-083961 filed in Japan on May 23, 2022, the entire contents of which are hereby incorporated by reference.

### TECHNICAL FIELD

The present invention relates to a vacuum-sealing device and a vacuum chamber device.

### BACKGROUND ART

Vacuum-sealing devices are used for carrying a sheet material into and out of a vacuum chamber. Patent Literature 1 discloses a vacuum-sealing device including a group of rolls that rotatably closely contact each other and that are arranged in pairs, each pair being constituted by rolls that are opposed to each other across the plane in which a sheet-shaped member moves (see the abstract). The roll 18 of the group of rolls is pushed against the wear-resistant member 19 provided in a vacuum chamber so that the airtightness between the roll 18 and the wear-resistant member 19 is maintained (see paragraph [0024] and FIG. 2). In addition, the rotating rolls 16, 17, and 18 are in contact with the dust seal member 38 (see paragraph [0030] and FIGS. 2 and 5).

### CITATION LIST

### Patent Literature

### Patent Literature 1

Japanese Patent Application Publication, Tokukai, No. 2008-115897

### SUMMARY OF INVENTION

### Technical Problem

In the technique of Patent Literature 1, the rotating roll 18 and the wear-resistant member 19, which is stationary, contact each other, and in addition, a pushing force works therebetween. Accordingly, a great friction force is generated between the roll 18 and the wear-resistant member 19, and the roll 18 thus wears. This makes powder (dust) likely to be generated. Further, due to a friction between the rotating rolls 16, 17, and 18 and the dust seal member 38, the rolls 16, 17, and 18 or the dust seal member 38 wear(s). This makes powder (dust) likely to be generated. The dust thus generated can deteriorate the environment inside the vacuum chamber.

An object of an aspect of the present invention is to provide a vacuum-sealing device and a vacuum chamber device that achieve compatibility between (i) maintenance of airtightness and (ii) a reduction in friction generated between a rotating member and a stationary member.

### Solution to Problem

In order for the above problem to be solved, a vacuum-sealing device in accordance with an aspect of the present invention includes: a first roll that has a first outer circumferential surface made of a first elastic material and that is rotationally symmetric about a first central axis line; a second roll having a second outer circumferential surface which is made of a second elastic material and which contacts the first outer circumferential surface of the first roll, the second roll being rotationally symmetric about a second central axis line in parallel with the first central axis line; a first holding member including: a first space in which the first roll is held and which has an axis coincident with an axis of the first roll; and a first inner circumferential surface that defines the first space and that faces the first outer circumferential surface; and a second holding member including: a second space in which the second roll is held and which has an axis coincident with an axis of the second roll; and a second inner circumferential surface that defines the second space and that faces the second outer circumferential surface, the second holding member and the first holding member being opposed to each other so as to have a gap therebetween, rotation of the first roll and the second roll in correspondence with each other causing a sheet material to pass between the first roll and the second roll and through the gap.

### Advantageous Effects of Invention

According to an aspect of the present invention, it is possible to provide a vacuum-sealing device and a vacuum chamber device that achieve compatibility between (i) maintenance of airtightness and (ii) a reduction in friction generated between a rotating member and a stationary member.

### BRIEF DESCRIPTION OF DRAWINGS

FIG. 1 is a diagram of a vacuum system in accordance with an embodiment of the present invention.

FIG. 2 is a perspective view of an example of a vacuum-sealing device in accordance with an embodiment of the present invention.

FIG. 3 is a partial cross-sectional view of the vacuum-sealing device in lateral view.

FIG. 4 is a partial cross-sectional view of the vacuum-sealing device in plan view.

FIG. 5 is a perspective view of an example of a vacuum-sealing device in accordance with a Variation of the present invention.

### DESCRIPTION OF EMBODIMENTS

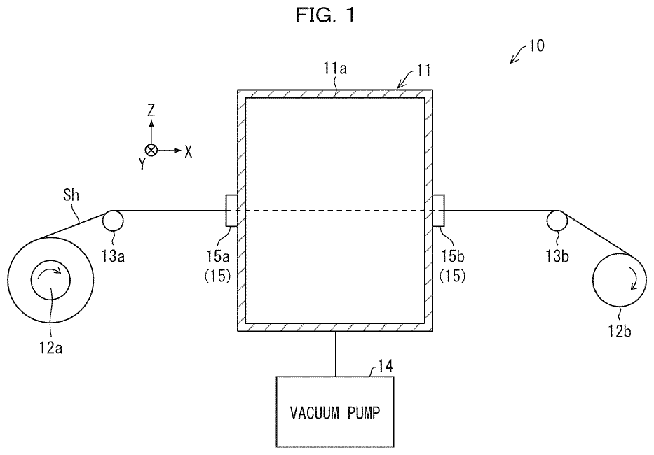

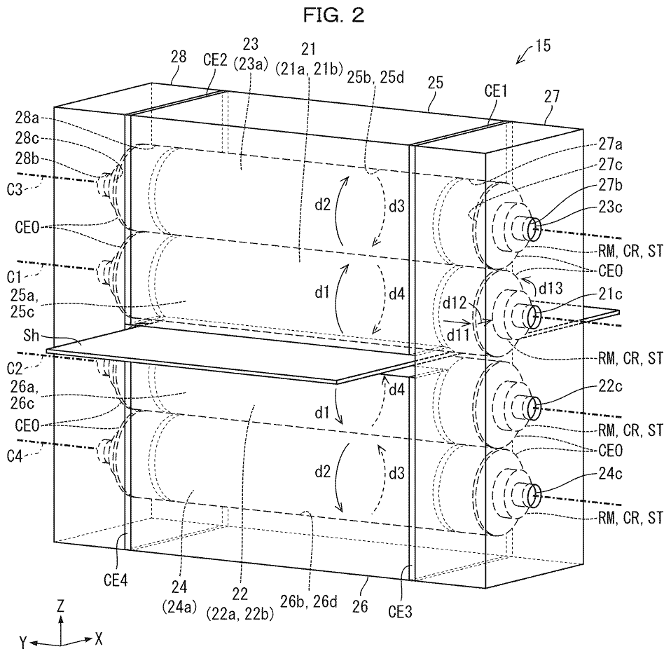

The following description will discuss an embodiment of the present invention in detail. FIG. 1 is a diagram of a vacuum system 10 in accordance with an embodiment of the present invention. In FIG. 1, an XYZ coordinate is set. In the XYZ coordinate, the vertical direction is a Z axis and the conveyance direction of a sheet material Sh is an X axis. This XYZ coordinate is used also in FIGS. 2 to 5, which will be described later.

The vacuum system 10 is a system that allows treatment of the sheet material Sh under vacuum, and includes: a vacuum chamber device 11; a delivery roller 12a; holding rollers 13a and 13b; and a wind-up roller 12b. The vacuum chamber device 11 includes: a vacuum chamber 11a; a vacuum pump 14 for keeping the inside of the vacuum chamber 11a in a vacuum state; a vacuum-sealing device 15a for carrying the sheet material Sh into the vacuum chamber 11a; and a vacuum-sealing device 15b for carrying the sheet material Sh out of the vacuum chamber 11a.

The delivery roller 12a and the wind-up roller 12b rotate in correspondence with each other, so that the sheet material Sh is conveyed from the delivery roller 12a toward the wind-up roller 12b (in a positive X-axis direction). The sheet material Sh delivered by the delivery roller 12a is carried into the vacuum chamber 11a through the holding roller 13a and the vacuum-sealing device 15a. The sheet material Sh carried into the vacuum chamber 11a undergoes various kinds of treatment (e.g., application of a coating to the surface). Upon completion of the treatment, the sheet material Sh is carried out of the vacuum chamber 11a through the vacuum-sealing device 15b, passes the holding roller 13b, and is wound up by the wind-up roller 12b.

Although having different roles of carrying the sheet material Sh into and out of the vacuum chamber, the vacuum-sealing devices 15a and 15b can have substantially the same configuration. Therefore, the vacuum-sealing devices 15a and 15b are hereinafter expressed collectively as the vacuum-sealing device 15.

### Details of Vacuum-Sealing Device 15

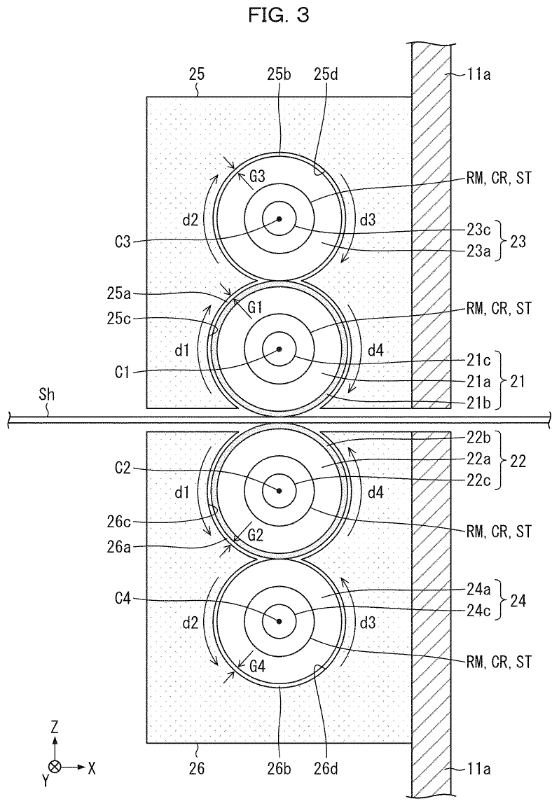

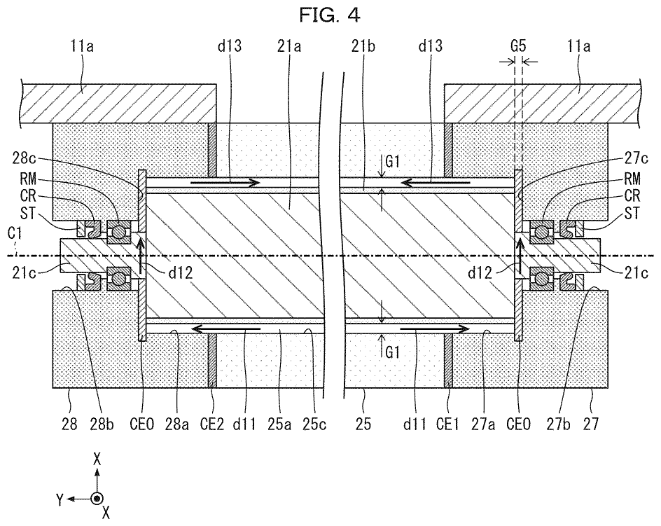

The details of the vacuum-sealing device 15 are described below. FIG. 2 is a perspective view of the vacuum-sealing device 15, FIG. 3 is a partial cross-sectional view of the vacuum-sealing device 15 in lateral view (seen from the negative side of a Y axis), and FIG. 4 is a partial cross-sectional view of the vacuum-sealing device 15 in plan view (seen from the positive side of the Z axis).

The vacuum-sealing device 15 includes: sheet rolls 21 and 22 and backup rolls 23 and 24 (hereinafter also referred to as sheet roll 21 and the others); and holding members 25 to 28, as illustrated in FIG. 2.

The sheet roll 21 and the others are arranged straight in the Z-axis direction (vertically) (straight in a direction orthogonal to central axes C1 to C4 of the sheet roll 21 and the others). The central axes C1 to C4 of the sheet roll 21 and the others are arranged in parallel (e.g., parallel to each other).

The sheet roll 21 and the others are arranged vertically in the order of the backup roll 23, the sheet roll 21, the sheet roll 22, and the backup roll 24 so as to make contact. Specifically, the outer circumferential surface (first outer circumferential surface: the periphery of an outer circumferential portion 21b, which will be described later) of the sheet roll 21 (first roll) contacts, in the lower part of the sheet roll 21, the outer circumferential surface (second outer circumferential surface: the periphery of an outer circumferential portion 22b, which will be described later) of the sheet roll 22 (second roll), and contacts, in the upper part of the sheet roll 21, the outer circumferential surface (third outer circumferential surface: the periphery of an outer circumferential shaft portion 23a, which will be described later) of the backup roll 23 (third roll). The outer circumferential surface of the sheet roll 22 contacts, in the lower part of the sheet roll 22, the outer circumferential surface (fourth outer circumferential surface: the periphery of an outer circumferential shaft portion 24a, which will be described later) of the backup roll 24 (fourth roll).

As above, the sheet rolls 21 and 22 and the backup rolls 23 and 24 are in contact relationship. Accordingly, when, for example, the sheet rolls 21 and 22 rotate in correspondence with each other, the backup rolls 23 and 24 also rotate along with the rotation of the sheet rolls 21 and 22. Specifically, a first rotation mechanism (a power source such as a motor) causes the sheet roll 21 to rotate. A second rotation mechanism (a power source such as a motor) causes the sheet roll 22 to rotate in correspondence with the sheet roll 21. The first and second rotation mechanisms may be formed by respective power sources independent of each other. Alternatively, the first and second rotation mechanisms may be formed by power sources which are integral with each other and which operate in conjunction with each other by the linking capability of, for example, gears.

The backup roll 23, the backup roll 24, or the backup rolls 23 and 24 may rotate in conjunction with the sheet rolls 21 and 22. For example, a third rotation mechanism (a power source such as a motor) causes the backup roll 23 to rotate in correspondence with the sheet rolls 21 and 22. Further, a fourth rotation mechanism (a power source such as a motor) causes the backup roll 24 to rotate in correspondence with the sheet rolls 21 and 22 and the backup roll 23. The first to fourth rotation mechanisms may be formed by respective power sources independent of each other. At least some of the first to fourth rotation mechanisms may formed by power sources which are integral with each other and which operate in conjunction with each other by the linking capability of, for example, gears.

By causing the sheet rolls 21 and 22 to rotate in contact with each other and in correspondence with each other, it is possible to cause the sheet material Sh to pass between the sheet rolls 21 and 22. It is possible to set the conveyance direction of the sheet material Sh to either the positive X-axis direction or the negative x-axis direction according to the rotation direction of the sheet rolls 21 and 22. The vacuum-sealing device 15 can therefore function not only as the vacuum-sealing device 15a for the carry-in purpose in FIG. 1 but also as the vacuum-sealing device 15b for the carryout purpose illustrated in FIG. 1.

As will be described later, the outer circumferential surfaces (the peripheries of the outer circumferential portions 21b and 22b) of the sheet rolls 21 and 22 are elastic. It is therefore possible to maintain airtightness between the sheet rolls 21 and 22 when the sheet rolls 21 and 22 rotate to cause the sheet material Sh to pass. For example, even if there are a certain number of irregularities in the sheet material Sh, the sheet rolls 21 and 22 deform according to the irregularities, so that the airtightness between the sheet rolls 21 and 22 is maintained.

As will be described later, the backup rolls 23 and 24, in particular, the outer circumferential surfaces thereof (the peripheries of the outer circumferential shaft portions 23a and 24a, which will be described later), are rigid. It is therefore possible for the backup rolls 23 and 24 to correct deflections of the roller 21 and 22 and thereby improve the airtightness between the sheet rolls 21 and 22. The details of this will be described later.

The sheet roll 21 and the backup roll 23 are held by the holding members 25, 27, and 28. The sheet roll 22 and the backup roll 24 are held by the holding members 26, 27, and 28. The holding members 25 and 26 are opposed to each other so as to have a gap therebetween in the Z-axis direction (vertically). The holding members 27 and 28 are disposed on the respective opposite sides of the holding members 25 and 26 in the Y-axis direction.

The gap between the holding members 25 and 27, the gap between holding members 25 and 28, the gap between holding members 26 and 27, and the gap between the holding members 26 and 28 are sealed with use of a sealing members CE1, CE2, CE3, and CE4, respectively. The sealing members CE1 to CE4 have openings that allow the sheet rolls 21 and 22 and backup rolls 23 and 24 to pass therethrough.

The sheet roll 21 includes a shaft portion 21a and the outer circumferential portion 21b, as illustrated in FIGS. 3 and 4. The shaft portion 21a and the outer circumferential portion 21b each are rotationally symmetric about the central axis line C1. The shaft portion 21a is substantially cylindrical and rotates about the central axis line C1. The outer circumferential portion 21b covers the shaft portion 21a, substantially has the shape of a hollow cylinder, and rotates together with the shaft portion 21a. A rotational shaft 21c protrudes from each of the opposite end portions of the shaft portion 21a (sheet roll 21). The shaft portion 21a and the rotational shaft 21c are made of a rigid material such as metal or plastic. The outer circumferential portion 21b is made of an elastic material such as rubber (e.g., nitrile rubber) or sponge. Thus, the sheet roll 21 (first roll) has the first outer circumferential surface (the periphery of the outer circumferential portion 21b) made of a first elastic material and is rotationally symmetric about a first central axis line (central axis line C1).

Like the sheet roll 21, the sheet roll 22 includes a shaft portion 22a and the outer circumferential portion 22b, and a rotational shaft 22c protrudes from each of the opposite end portions of the shaft portion 22a (sheet roll 22). The sheet roll 22 (second roll) has the second outer circumferential surface (the periphery of the outer circumferential portion 22b) which is made of a second elastic material and which contacts the outer circumferential surface (first outer circumferential surface) of the sheet roll 21, and is rotationally symmetric about a second central axis line (central axis line C2) which is in parallel with the first central axis line (central axis line C1). Since the sheet roll 22 has a configuration corresponding to that of the sheet roll 21, the detailed description thereof is omitted.

The backup roll 23 has the outer circumferential shaft portion 23a. The outer circumferential shaft portion 23a is rotationally symmetric about a central axis line C3. The outer circumferential shaft portion 23a is substantially cylindrical and rotates about the central axis line C3. A rotational shaft 23c protrudes from each of the opposite end portions of the outer circumferential shaft portion 23a (backup roll 23). The outer circumferential shaft portion 23a and the rotational shaft 23c are made of a rigid material such as metal or plastic. Thus, the backup roll 23 (third roll) has a third outer circumferential surface which is made of a first rigid material and which contacts the first outer circumferential surface (the outer circumferential surface of the sheet roll 21), and is rotationally symmetric about a third central axis line (central axis line C3) which is in parallel with the first and second central axis lines (central axis lines C1 and C2).

Like the backup roll 23, the backup roll 24 has the outer circumferential shaft portion 24a, and a rotational shaft 24c protrudes from each of the opposite end portions of the outer circumferential shaft portion 24a (backup roll 23). The backup roll 24 (fourth roll) has the fourth outer circumferential surface which is made of a second rigid material and which contacts the second outer circumferential surface (the outer circumferential surface of the sheet roll 22), and is rotationally symmetric about a fourth central axis line (central axis line C4) which is in parallel with the first, second, and third central axis lines (central axis lines C1, C2, and C3). Since the backup roll 24 has a configuration corresponding to that of the backup roll 23, the detailed description thereof is omitted.

The holding member 25 includes: a space 25a (first space) in which the sheet roll 21 is held; a space 25b (third space) in which the backup roll 23 is held; an inner circumferential surface 25c (first inner circumferential surface) that defines the space 25a; and an inner circumferential surface 25d (third inner circumferential surface) that defines the space 25b, as illustrated in FIG. 3. The space 25a is in communication with the space 25b, and is open on the negative side of the holding member 25 in the Z-axis direction.

The space 25a is substantially cylindrical, and has an axis coincident with the central axis line C1. The inner circumferential surface 25c (first inner circumferential surface) defines the space 25a (first space), and faces the outer circumferential surface (first outer circumferential surface) of the sheet roll 21. The inner circumferential surface 25c of the space 25a and the outer circumferential surface of the sheet roll 21 face each other, and form a gap G1 (first gap) therebetween. The gap G1 restricts a gas (air) flow along the inner circumferential surface 25c of the holding member 25 while enabling the sheet roll 21 to rotate in relation to the holding member 25. The size of the gap G1 is defined by the difference between the radius of the space 25a, which is substantially cylindrical, and the radius of the sheet roll 21, which is substantially cylindrical.

The space 25b is substantially cylindrical, and has an axis coincident with the central axis line C3. The inner circumferential surface 25d (third inner circumferential surface) defines the space 25b (third space) and faces the outer circumferential surface (third outer circumferential surface) of the backup roll 23. The inner circumferential surface 25d of the space 25b and the outer circumferential surface of the backup roll 23 face each other and form a gap G3 (third gap) therebetween. The gap G3 restricts a gas (air) flow along the inner circumferential surface 25d of the holding member 25 while enabling the backup roll 23 to rotate in relation to the holding member 25. The size of the gap G3 is defined by the difference between the radius of the space 25b, which is substantially cylindrical, and the radius of the backup roll 23, which is substantially cylindrical.

The gap G1 and the gap G3 are in communication with each other, and collectively function as a labyrinth seal. Specifically, as illustrated in FIG. 3, when air enters the gap G1 from the negative side of the sheet roll 21 in the X-axis direction, this air follows a path d1, moves to the negative side of the gap G3 in the X-axis direction, follows paths d2 and d3, reaches the positive side of the gap G1 in the X-axis direction, follows a path d4, and reaches the inside of the vacuum chamber 11a. As above, the air reaches the inside of the vacuum chamber 11a only when following the paths d1 to d4. Having to follow the long and narrow paths d1 to d4 restricts the entry of the air into the vacuum chamber 11a.

The holding member 26 includes: a space 26a (second space) in which the sheet roll 22 is held; a space 26b (fourth space) in which the backup roll 24 is held; an inner circumferential surface 26c (second inner circumferential surface) that defines the space 26a; and an inner circumferential surface 26d (fourth inner circumferential surface) that defines the space 26d. The space 26a is in communication with the space 26b, and is open on the positive side of the holding member 25 in the Z-axis direction.

The space 26a is substantially cylindrical, and has an axis coincident with the central axis line C2. The inner circumferential surface 26c (second inner circumferential surface) defines the space 26a (second space) and faces the outer circumferential surface (second outer circumferential surface) of the sheet roll 22. The inner circumferential surface 26c of the space 26a and the outer circumferential surface of the sheet roll 22 face each other, and form a gap G2 (second gap) therebetween. The gap G2 restricts a gas (air) flow along the inner circumferential surface 26c of the holding member 26 while enabling the sheet roll 22 to rotate in relation to the holding member 26. The size of the gap G2 is defined by the difference between the radius of the space 26a, which is substantially cylindrical, and the radius of the sheet roll 22, which is substantially cylindrical.

The space 26b is substantially cylindrical, and has an axis coincident with the central axis line C4. The inner circumferential surface 26d (fourth inner circumferential surface) defines the space 26b (fourth space) and faces the outer circumferential surface (fourth outer circumferential surface) of the backup roll 24. The inner circumferential surface 26d of the space 26b and the outer circumferential surface of the backup roll 24 face each other and form a gap G4 (fourth gap) therebetween. The gap G4 restricts a gas (air) flow along the inner circumferential surface 26d of the holding member 26 while enabling the backup roll 24 to rotate in relation to the holding member 26. The size of the gap G4 is defined by the difference between the radius of the space 26b, which is substantially cylindrical, and the radius of the backup roll 24, which is substantially cylindrical.

The gaps G2 and G4 are in communication with each other, and collectively function as a labyrinth seal. Since the gaps G2 and G4 correspond to the gaps G1 and G3 of the holding member 25, the detailed descriptions thereof are omitted.

The holding member 27 (third holding member) includes a space 27a (fifth space) and a through-hole 27b, as illustrated in FIG. 4. The holding member 27 holds the end portion of the sheet roll 21 (the shaft portion 21a and the outer circumferential portion 21b) in the space 27a, which is substantially cylindrical. The holding member 27 has an inner surface 27c that defines the space 27a and that faces the end portion (end face) of the sheet roll 21. The through-hole 27b is in communication with the space 27a, and has the rotational shaft 21c disposed therein. It is possible to connect a rotation mechanism such as a motor to the rotational shaft 21c through the through-hole 27b. In the space 27a and the through-hole 27b, a rotating member RM, a rotation sealing member CR, a fixing member ST, and an end sealing member CE0 are disposed.

The rotating member RM is, for example, a bearing mechanism, and fixes the rotational shaft 21c so as to enable the rotational shaft 21c to rotate in relation to the through-hole 27b. The rotation sealing member CR is, for example, an oil seal (e.g., an O-ring), and seals a space between the rotational shaft 21c and the through-hole 27b so as to enable the rotational shaft 21c to rotate. The rotation sealing member CR is fixed to the holding member 27 via the fixing member ST having the shape of, for example, an O-ring. The end sealing member CE0 is, for example, an O-ring, and seals the space between the end portion of the sheet roll 21 and the inner surface 27c.

As illustrated in the right-hand part of FIG. 4, when air enters the gap G1 on the negative side of the sheet roll 21 in the X-axis direction, this air can enter the inside of the vacuum chamber 11a by flowing through the gap G1 in the negative Y-axis direction (path d11), reaching the end of the sheet roll 21, moving on the end face in the positive X-axis direction (path d12), reaching an end of the sheet roll 21 in the negative Y-axis direction, and moving through the gap G1 on the positive side of the X-axis direction (path d13). In such a situation, sealing a gap G5 lying between the end portion of the sheet roll 21 and the inner surface 27c of the space 27a allows the restriction of the entry of air through the gap G5 while enabling the sheet roll 21 to rotate.

The paths d11, d12, and d13 function as a kind of a labyrinth seal. It is thus possible for air to reach the inside of the vacuum chamber 11a only when passing through the paths d11, d12, and d13. Accordingly, the paths d11, d12, and d13 that are long and narrow allows the restriction of the entry of air. In addition, disposing the end sealing member CE0 between the end portion of the sheet roll 21 and the inner surface 27c allows an improvement in airtightness.

The holding member 27 includes the space, the through-hole, the inner surface, the rotating member RM, the rotation sealing member CR, the fixing member ST, and the end sealing member CE0 that are associated with the backup roll 23. Since the space, through-hole, and inner surface correspond to the space 27a, the through-hole 27b, and the inner surface 27c, the detailed descriptions thereof are omitted.

The holding member 28 includes the space 28a, the through-hole 28b, the inner surface 28c, the rotating member RM, the rotation sealing member CR, the fixing member ST, and the end sealing member CE0 that are associated with the sheet roll 22. The holding member 28 includes the space, the through-hole, the inner surface, the rotating member RM, the rotation sealing member CR, the fixing member ST, and the end sealing member CE0 that are associated with the backup roll 24. Since the space 28a, the through-hole 28b, the inner surface 28c, etc. correspond to the space 27a, the through-hole 27b, and the inner surface 27c of the holding member 27, the detailed descriptions thereof are omitted.

The backup rolls 23 and 24, which are rigid, correct deflections of the sheet rolls 21 and 22. This allows an improvement in the airtightness between the sheet rolls 21 and 22. The sheet rolls 21 and 22 and the backup rolls 23 and 24 are arranged straight in a direction orthogonal to the central axes C1 to C4. By applying pressure to the sheet rolls 21 and 22 from above and below via the backup rolls 23 and 24, it is possible to more effectively correct the deflections of the sheet rolls 21 and 22 and thereby improve the sealing property.

The backup roll 23, which is rigid, is easily processed with high precision. It is therefore possible to improve the sealing property by reducing the gap G2 between the holding member 25 and the inner circumferential surface 25d in order to make the gap G2 difficult for air to flow therethrough, while enabling the backup roll 23 to rotate. It is thus possible to improve the labyrinth-sealing property in the gaps G1 and G3 and in the gaps G2 and G4 by making the gaps G3 and G4 of the backup rolls 23 and 24 narrower than the gaps G1 and G2 of the sheet rolls 21 and 22 (G3, G4<G1, G2). For example, the gaps G1 and G2 and the gaps G3 and G4 can be 0.2 mm to 0.6 mm and 0.02 mm to 0.1 mm, respectively.

### Variation

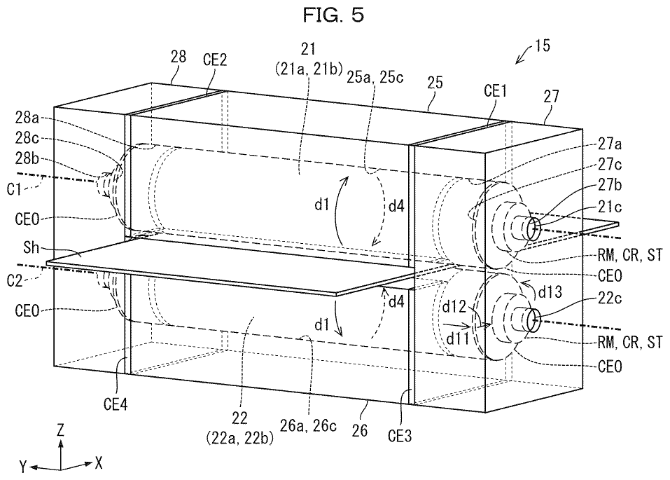

FIG. 5 is a perspective view of an example of a vacuum-sealing device 15 in accordance with a Variation of the present invention. The vacuum-sealing device 15 in accordance with the Variation does not include the backup rolls 23 and 24, and the holding members 25 to 28 do not include spaces to hold the backup rolls 23 and 24. In this case, each of the gaps G1 and G3 functions as a labyrinth seal by itself.

### Conclusion

As above, according to the present embodiment, the rotating members (sheet rolls 21 and 22, backup rolls 23 and 24) are rotatably sealed due to the surrounding gaps G1, G2, G3, and G4 (labyrinth seal). This achieves the compatibility between (i) the sealing and (ii) the abilities of the sheet rolls 21 and 22 and the backup rolls 23 and 24 to rotate. The rotating members do not need to substantially contact the stationary members (holding members 25 to 28). It is therefore possible to reduce wear caused by the friction between the rotating members and the stationary members.

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

A vacuum-sealing device in accordance with Aspect 1 includes: a first roll that has a first outer circumferential surface made of a first elastic material and that is rotationally symmetric about a first central axis line; a second roll having a second outer circumferential surface which is made of a second elastic material and which contacts the first outer circumferential surface of the first roll, the second roll being rotationally symmetric about a second central axis line in parallel with the first central axis line; a first holding member including: a first space in which the first roll is held and which has an axis coincident with an axis of the first roll; and a first inner circumferential surface that defines the first space and that faces the first outer circumferential surface; and a second holding member including: a second space in which the second roll is held and which has an axis coincident with an axis of the second roll; and a second inner circumferential surface that defines the second space and that faces the second outer circumferential surface, the second holding member and the first holding member being opposed to each other so as to have a gap therebetween, rotation of the first roll and the second roll in correspondence with each other causing a sheet material to pass between the first roll and the second roll and through the gap.

According to a vacuum-sealing device of Aspect 2, in the vacuum-sealing device described in Aspect 1, a first gap is formed between the first outer circumferential surface and the first inner circumferential surface, the first gap restricting a gas flow along the first inner circumferential surface while enabling the first roll to rotate in relation to the first holding member, and a second gap is formed between the second outer circumferential surface and the second inner circumferential surface, the second gap restricting a gas flow along the second inner circumferential surface while enabling the second roll to rotate in relation to the second holding member.

According to a vacuum-sealing device of Aspect 3, in the vacuum-sealing device described in Aspect 1 or 2, the first elastic material and the second elastic material are rubber or sponge.

According to a vacuum-sealing device of Aspect 4, the vacuum-sealing device described in any one of Aspects 1 to 3 further includes: a first rotation mechanism for rotating the first roll; and a second rotation mechanism for rotating the second roll in correspondence with the first roll.

According to a vacuum-sealing device of Aspect 5, the vacuum-sealing device described in any one of Aspects 1 to 4 further includes: a third roll having a third outer circumferential surface that is made of a first rigid material and that contacts the first outer circumferential surface, and being rotationally symmetric about a third central axis line in parallel with the first central axis line and the second central axis line; and a fourth roll having a fourth outer circumferential surface that is made of a second rigid material and that contacts the second outer circumferential surface, and being rotationally symmetric about a fourth central axis line in parallel with the first central axis line, the second central axis line, and the third central axis line, the first holding member includes: a third space in which the third roll is held and which has an axis coincident with an axis of the third roll; and a third inner circumferential surface that defines the third space and that faces the third outer circumferential surface, the second holding member includes: a fourth space in which the fourth roll is held and which has an axis coincident with an axis of the fourth roll; and a fourth inner circumferential surface that defines the fourth space and that faces the fourth outer circumferential surface, and rotation of the first roll causes the second roll, the third roll, and the fourth roll to rotate.

According to a vacuum-sealing device of Aspect 6, in the vacuum-sealing device described in Aspect 5, a third gap is formed between the third inner circumferential surface and the third outer circumferential surface, the third gap restricting a gas flow along the third inner circumferential surface while enabling the third roll to rotate in relation to the first holding member, and
a fourth gap is formed between the fourth inner circumferential surface and the fourth outer circumferential surface, the fourth gap restricting a gas flow along the fourth inner circumferential surface while enabling the fourth roll to rotate in relation to the second holding member.

According to a vacuum-sealing device of Aspect 7, in the vacuum-sealing device described in Aspect 5 or 6, the first rigid material and the second rigid material are metal or plastic.

According to a vacuum-sealing device of Aspect 8, in the vacuum-sealing device described in any one of Aspects 5 to 7, the first roll, the second roll, the third roll, and the fourth roll are arranged straight in a direction orthogonal to the first central axis line, the second central axis line, the third central axis line, and the fourth central axis line.

According to a vacuum-sealing device of Aspect 9, the vacuum-sealing device described in any one of Aspects 5 to 8 further includes: a third rotation mechanism for rotating the third roll in correspondence with the first roll and the second roll; and a fourth rotation mechanism for rotating the fourth roll in correspondence with the first roll, the second roll, and the third roll.

According to a vacuum-sealing device of Aspect 10, the vacuum-sealing device described in any one of Aspects 1 to 9 further includes: a rotational shaft protruding from an end portion of the first roll; a third holding member including: a fifth space in which the end portion is held; an inner surface that defines the fifth space and that faces the end portion; and a through-hole that has the rotational shaft disposed therein; a rotation sealing member for sealing a space between the rotational shaft and the through-hole so as to enable the rotational shaft to rotate; and an end sealing member for sealing a space between the end portion and the inner surface.

A vacuum chamber device of Aspect 11 includes: a vacuum chamber; a vacuum pump for evacuating the vacuum chamber; and one or more vacuum-sealing devices each of which is the vacuum-sealing device described in any one of Aspects 1 to 10, the sheet material being carried into the vacuum chamber or being carried out of the vacuum-sealing device via the one or more vacuum-sealing devices.

### REFERENCE SIGNS LIST

11: Vacuum chamber device,
15: Vacuum-sealing device,
21, 22: Sheet roll,
23, 24: Backup roll,
25, 26, 27, 28: Holding member

1. A vacuum-sealing device comprising:
a first roll that has a first outer circumferential surface made of a first elastic material and that is rotationally symmetric about a first central axis line;
a second roll having a second outer circumferential surface which is made of a second elastic material and which contacts the first outer circumferential surface of the first roll, the second roll being rotationally symmetric about a second central axis line in parallel with the first central axis line;
a first holding member including: a first space in which the first roll is held and which has an axis coincident with an axis of the first roll; and a first inner circumferential surface that defines the first space and that faces the first outer circumferential surface; and
a second holding member including: a second space in which the second roll is held and which has an axis coincident with an axis of the second roll; and a second inner circumferential surface that defines the second space and that faces the second outer circumferential surface, the second holding member and the first holding member being opposed to each other so as to have a gap therebetween,
rotation of the first roll and the second roll in correspondence with each other causing a sheet material to pass between the first roll and the second roll and through the gap.

2. The vacuum-sealing device according to claim 1, wherein
a first gap is formed between the first outer circumferential surface and the first inner circumferential surface, the first gap restricting a gas flow along the first inner circumferential surface while enabling the first roll to rotate in relation to the first holding member, and
a second gap is formed between the second outer circumferential surface and the second inner circumferential surface, the second gap restricting a gas flow along the second inner circumferential surface while enabling the second roll to rotate in relation to the second holding member.

3. The vacuum-sealing device according to claim 1, wherein
the first elastic material and the second elastic material are rubber or sponge.

4. The vacuum-sealing device according to claim 1, further comprising:
a first rotation mechanism for rotating the first roll; and
a second rotation mechanism for rotating the second roll in correspondence with the first roll.

5. The vacuum-sealing device according to claim 1, further comprising:
a third roll having a third outer circumferential surface that is made of a first rigid material and that contacts the first outer circumferential surface, and being rotationally symmetric about a third central axis line in parallel with the first central axis line and the second central axis line; and
a fourth roll having a fourth outer circumferential surface that is made of a second rigid material and that contacts the second outer circumferential surface, and being rotationally symmetric about a fourth central axis line in parallel with the first central axis line, the second central axis line, and the third central axis line,
the first holding member including: a third space in which the third roll is held and which has an axis coincident with an axis of the third roll; and a third inner circumferential surface that defines the third space and that faces the third outer circumferential surface,
the second holding member including: a fourth space in which the fourth roll is held and which has an axis coincident with an axis of the fourth roll; and a fourth inner circumferential surface that defines the fourth space and that faces the fourth outer circumferential surface,
rotation of the first roll causing the second roll, the third roll, and the fourth roll to rotate.

6. The vacuum-sealing device according to claim 5, wherein
a third gap is formed between the third inner circumferential surface and the third outer circumferential surface, the third gap restricting a gas flow along the third inner circumferential surface while enabling the third roll to rotate in relation to the first holding member, and
a fourth gap is formed between the fourth inner circumferential surface and the fourth outer circumferential surface, the fourth gap restricting a gas flow along the fourth inner circumferential surface while enabling the fourth roll to rotate in relation to the second holding member.

7. The vacuum-sealing device according to claim 5, wherein
the first rigid material and the second rigid material are metal or plastic.

8. The vacuum-sealing device according to claim 5, wherein
the first roll, the second roll, the third roll, and the fourth roll are arranged straight in a direction orthogonal to the first central axis line, the second central axis line, the third central axis line, and the fourth central axis line.

9. The vacuum-sealing device according to claim 5, further comprising:
a third rotation mechanism for rotating the third roll in correspondence with the first roll and the second roll; and
a fourth rotation mechanism for rotating the fourth roll in correspondence with the first roll, the second roll, and the third roll.

10. The vacuum-sealing device according to claim 1, further comprising:
a rotational shaft protruding from an end portion of the first roll;
a third holding member including: a fifth space in which the end portion is held; an inner surface that defines the fifth space and that faces the end portion; and a through-hole that has the rotational shaft disposed therein;
a rotation sealing member for sealing a space between the rotational shaft and the through-hole so as to enable the rotational shaft to rotate; and
an end sealing member for sealing a space between the end portion and the inner surface.

11. A vacuum chamber device comprising:
a vacuum chamber;
a vacuum pump for evacuating the vacuum chamber; and
one or more vacuum-sealing devices each of which is the vacuum-sealing device according to claim 1,
the sheet material being carried into the vacuum chamber or being carried out of the vacuum-sealing device via the one or more vacuum-sealing devices.
